(19) United States
(12) Patent Application Publication
(10) Pub. No.: US 2009/0110460 A1
(43) Pub. Date: Apr. 30, 2009

(54) SHEET MOISTURIZING DEVICE AND IMAGE FORMING APPARATUS PROVIDED THEREWITH

(75) Inventors: Toshio Shida, Tokyo (JP); Masashi Kougami, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/128,065

(22) Filed: May 28, 2008

(30) Foreign Application Priority Data
Oct. 30, 2007 (JP) JP2007-281481

(51) Int. Cl. G03G 15/00

(52) U.S. Cl. 399/406

(57) ABSTRACT

A sheet moisturizing device having a moisturizing section that moisturizes a sheet and a guide which guides the sheet that has been moisturized by the moisturizing section, the guide includes a first guide member made of resin having a plurality of ribs, arranged immediately downstream of the moisturizing section in a sheet conveyance direction, which guides the sheet in a vertical direction.

This application is based on Japanese Patent Application No. 2007-281481 filed on Oct. 30, 2007, which is incorporated hereinto by reference.

### BACKGROUND OF THE INVENTION

The present invention relates to a sheet moisturizing device that moisturizes sheets and an image forming apparatus provided with the sheet moisturizing device

In an image forming apparatus of an electrophotographic type, namely, in a copying machine, a printer, a facsimile machine and a multifunction peripheral having functions thereof, there is a problem that a sheet is curled and is deformed to be corrugated because a sheet is dehydrated in the fixing process. As a means to solve this problem, there has been suggested a technology to moisturize a sheet after the sheet is fixed.

Unexamined Japanese Patent Application Publication No. 2006-8282 is one to supply water to a sheet with a moisturizing roller that forms a nip portion that conveys a sheet.

There is further proposed a dew condensation prevention device to be provided in a conveyance path, because conveyance troubles for a sheet are caused by moisture sticking on parts constituting a sheet conveyance path such as a guide member, under dew condensation.

Namely, in Unexamined Japanese Patent Application Publication No. 08-211819, there is proposed to provide a dew condensation prevention device on a post-processing apparatus that is on the downstream side of a fixing unit.

In Unexamined Japanese Patent Application Publication No. 08-211672, there is described that dew condensation is prevented by providing a heater in a conveyance path that is on the downstream side of a fixing unit.

Further, in Unexamined Japanese Patent Application Publication No. 2000-226147, it is proposed to prevent conveyance troubles caused by waterdrops sticking to a guide member in a sheet moisturizing section in a sheet moisturizing device that supplies water to a sheet, by spraying waterdrops for the sheet.

In conveyance of the sheet supplied with water by a moisturizing device, dew condensation tends to be caused because humidity of an ambient atmosphere in the vicinity of the moisturizing device is high. Namely, waterdrops tend to stick to parts constituting a conveyance path.

The dew condensation of this kind causes a sheet to cling to parts constituting a conveyance path, and reasons explained below cause the sheet right after being moisturized to tend to cling to parts constituting a conveyance path.

In the case of the sheet right after being moisturized, the supplied moisture does not spread into the sheet sufficiently, and the moisture content on the surface is higher than that in the inside, thus, the sheet right after being processed in terms of moisturizing tends to cling to surrounding parts.

As stated above, conveyance of the sheet that has been subjected to moisturizing processing has a problem which does not exist in an ordinary sheet conveyance, and it is difficult for the conventional way of dew condensation prevention to prevent conveyance troubles.

For example, even when dew condensation can be prevented in the conveyance path through which a sheet is conveyed in a horizontal direction or in an oblique direction as in the case of Unexamined Japanese Patent Application Publication Nos. 2006-8282, 08-211819 and 08-211672, it is still impossible to avoid that the sheet right after being moisturized comes in contact with guide members which form the conveyance path, and there is a fear that a sheet may cling to a guide member when the sheet touches the guide member.

Further, Unexamined Japanese Patent Application Publication Nos. 2000-226147 wherein the sheet that is in the course of moisturizing processing is prevented from clinging to a guide member only cannot still prevent that a sheet right after being moisturized clings to a guide member.

### SUMMARY OF THE INVENTION

An aspect of the invention is as follows.

A sheet moisturizing device having therein a moisturizing section that moisturizes a sheet and a guide that guides the sheet that is moisturized by the moisturizing section, wherein the guide has a first guide member made of resin which is arranged immediately at the downstream side of the moisturizing device in the conveyance direction for the sheet, and which has a plurality of ribs to guide the sheet in the vertical direction.

Another aspect of the invention is as follows.

An image forming apparatus equipped with an image forming section that forms an image on a sheet and with the sheet moisturizing device described in the aforesaid one aspect that conducts moisturizing processing on the sheet on which an image has been formed in the image forming section.

### BRIEF DESCRIPTION OF THE DRAWINGS

FIG. 1 is an overall diagram of an image forming apparatus relating to an embodiment of the invention.

FIG. 2 is a sectional view of a sheet moisturizing device equipped with a sheet moisturizing section in an embodiment of the invention.

FIG. 3 is a sectional view of a sheet moisturizing section.

FIG. 4 is a side view of a guide member.

FIG. 5 is a sectional view of a sheet moisturizing section in another embodiment of the invention.

FIG. 6 is an enlarged view of a guide member.

FIG. 7 is a diagram showing the structure of a decurl device.

### DETAILED DESCRIPTION OF THE PREFERRED EMBODIMENT

The invention will be explained in detail as follows, referring to the embodiment, to which, however, the invention is not limited.

### <Image Forming Apparatus>

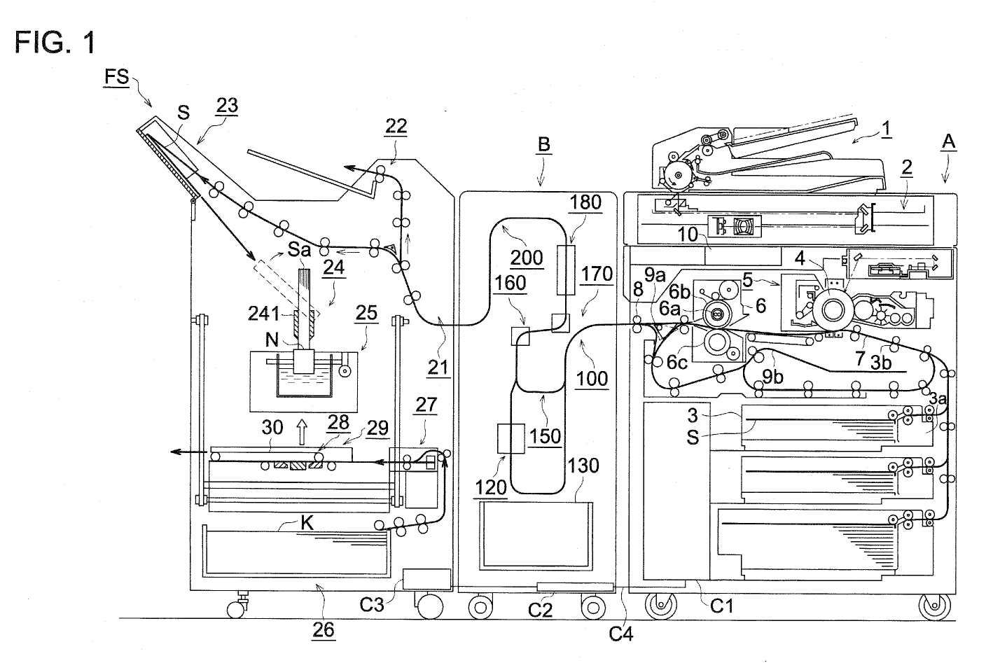

FIG. 1 is an overall diagram of an image forming apparatus relating to an embodiment of the invention, and the image forming apparatus is composed of image forming section A that forms an image on a sheet, sheet moisturizing device B and sheet finisher FS.

The image forming section A has, on its upper part, automatic document feeder 1 and image reading section 2, and a lower part of the image forming apparatus main body A is composed of a printer section.

In the printer section, the numeral 3 represents a sheet storing section that stores sheets S. In image forming unit (printer engine) 5 that forms a toner image on photoreceptor 4 through an electrophotographic process to conduct charging, exposure and development for photoreceptor 4, an image is formed on sheet S and the image thus formed is fixed by fixing unit 6. In the fixing unit 6, heat roller 6b housing therein heat source 6a and pressure roller 6c form a nip portion that conveys sheet S, thus, sheet S is heated and pressed, while it is conveyed, so that toner may be fused, and an image is fixed on sheet S.

The sheet S is fed by first sheet feeding unit 3a from sheet storing section 3, then, is fed after being stopped temporarily at second sheet feeding device 3b, so that image forming is conducted, and the sheet S on which an image has been formed is ejected from an ejection outlet by ejection rollers 8.

As a conveyance path for sheet S, there are provided sheet feeding path 7 covering from sheet storing section 3 to image forming unit 5, conveyance path 9a covering from image forming unit 5 to conveyance path 9a through fixing unit 6 and sheet ejection rollers 8 and rear surface conveyance path 9b that is for reversing conveyance.

An image forming mode includes a one-side face-down ejection mode, a one-side face-up ejection mode, and a two-side mode. In the one-side face-down ejection mode, an image is formed on one side, and sheet S which has passed through the fixing unit 6 is conveyed by sheet ejection rollers 8 to be ejected after being reversed inside out by reverse processing.

In the one-side face-up ejection mode, an image is formed on one side, and sheet S which has been conveyed through conveyance path 9a is conveyed by sheet ejection rollers 8 to be ejected.

In the two-side mode, an image is formed on one side and sheet S which has passed through the fixing unit 6 travels downward to advance to rear surface conveyance path 9b, and is fed to sheet feeding path 7 again after being reversed inside out.

In the image forming unit 5, a reverse side image is formed on the reverse side of the sheet S thus fed again, and the sheet S on which the reverse side image has been formed passes through the fixing unit 6, and is conveyed by the sheet ejection rollers 8 to be ejected.

The numeral 10 represents an operation section, and various types of modes in image forming apparatus main body A and an output mode employing sheet finisher FS can be established by operations in the operation section 10.

Controller C1 arranged on the image forming apparatus main body A is connected to controller C2 of sheet moisturizing device B and to controller C3 of sheet finisher FS through communication section C4.

Sheet S ejected from the image forming apparatus main body A is conveyed to the sheet finisher FS through sheet moisturizing device B.

The sheet moisturizing device B has therein first receiving and conveying section 100 that receives and conveys sheet S ejected from the image forming section A, sheet moisturizing section 120 that moisturizes sheets, second receiving and conveying section 150 that receives and conveys sheet S ejected from the image forming section A, first decurl section 160, second decurl section 170, third decurl section 180 and ejection and conveyance section 200 that ejects sheet S and delivers it to sheet finisher FS.

The sheet finisher FS is one that carries out various types of post processing for sheet S ejected from the image forming section A, and it includes generically a punching and folding machine, a flat binding machine, a center folding machine, a gluing and bookbinding machine and a cutting machine.

A gluing and bookbinding machine will be explained typically as an embodiment of the sheet finisher FS.

The gluing and bookbinding machine is equipped with sheet introduction section 21, sheet ejection section 22, sheet bundle storing section 23, sheet bundle conveyance section 24, glue coating section 25, cover sheet supply section 26, cover sheet cutting section 27, cover sheet wrapping section (case binding section) 28 and aligning section 29.

Sheet S introduced to sheet introduction section 21 is gradually conveyed downward obliquely after being placed on sheet bundle storing section, and is held by holding member 241 of sheet bundle conveyance section 24. The holding member 241 rotates while holding sheet bundle Sa so that a surface (a spine) that conducts coating of glue may come to the lower side, and stops at a prescribed position. The glue coating section 25 applies glue on the spine of the sheet bundle Sa.

Cover sheet K stored in cover sheet supply section 26 is conveyed to cover sheet wrapping section 28 through cover sheet cutting section 27, and then, a trailing edge section of the cover sheet K is cut to a prescribed length by the cover sheet cutting section 27. A length to which the cover sheet K is cut is one wherein a thickness of a spine of sheet bundle Sa is added to a length equivalent to two sheets S in their traveling direction.

The cover sheet wrapping section 28 receives cover sheet K supplied from the cover sheet supply section 26 and conveys it to conduct positioning in the lateral direction by aligning section 29, after stopping at a prescribed position. The cover sheet wrapping section 28 causes cover sheet K to come in pressure contact with glue coating surface N of sheet bundle Sa for adhesion.

The cover sheet K is folded along a side edge of glue coating surface N of sheet bundle Sa, by a descent of a pressure member that faces a spine of sheet bundle Sa and by a movement of a pair of folding members which are bilaterally symmetrical arranged on the upper portion of the cover sheet wrapping section 28, thus, sheet bundle Sa on which cover sheets K are mounted respectively on a surface and the reverse thereof is formed.

After an end of the folding process for cover sheet K, the cover sheet wrapping section 28 descends to retract, and then, ejection belt 30 that has been retreated toward the outside in the width direction of cover sheet K together with retreating of aligning section 29 moves to the inner side in the width direction at the lower part of sheet bundle Sa to stop. After that, when interposing by holding member 241 is released, the sheet bundle Sa descends and stops at the position where a lower spine of the sheet bundle Sa comes in contact with an upper surface of ejection belt 30. The rotating ejection belt 30 sticks over sheet K on sheet bundle Sa and ejects a booklet which has been subjected to wrapping processing out of the apparatus.

### [Sheet Moisturizing Device]

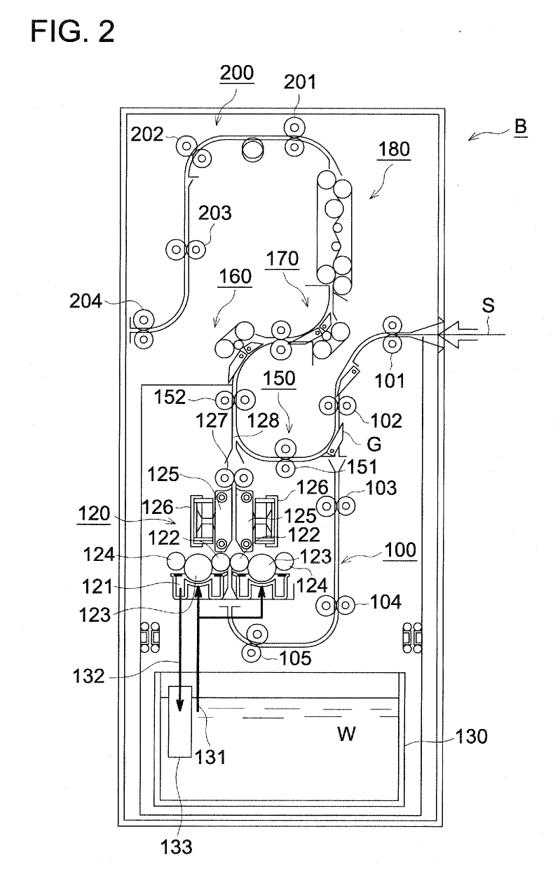

FIG. 2 is an overall diagram of sheet moisturizing device B relating to an embodiment of the invention.

Sheet S received by sheet moisturizing device B is conveyed, through switching operations of switching gate G, to first decurl section 160 through first receiving and conveying section 100 and second receiving and conveying path 150 to be ejected through second decurl section 170, third decurl section 180 and ejection and conveyance section 200, or the sheet S is conveyed to sheet moisturizing section 120 from the first receiving and conveying section 100, to be ejected out from sheet moisturizing section 120 through second receiving and conveying section 150, first to third decurl sections 160, 170 and 180 and ejection and conveyance section 200.

An occasion where moisturizing processing is conducted on sheet S will be explained in detail later. When using sheet moisturizing device B as only a sheet passage device without moisturizing sheet S, and when conducting decurl processing for sheet S, the sheet S is ejected through first carry-in and conveyance section 100, second carry-in and conveyance section 150, first decurl section 160, second decurl section 170 and third decurl section 180.

In the first receiving and conveying section 100, the sheet S is conveyed by conveyance rollers 101 to 105.

In the sheet moisturizing section 120, the sheet S is conveyed by moisturizing rollers 122 and 123 and by conveyance rollers 127.

In the second receiving and conveying section 150, the sheet S is conveyed by conveyance rollers 151 and 152.

In the ejection and conveyance section 200, the sheet S is conveyed by conveyance rollers 201 to 204 and is ejected.

Next, each processing section of sheet moisturizing device B will be explained.

### <Sheet Moisturizing Section>

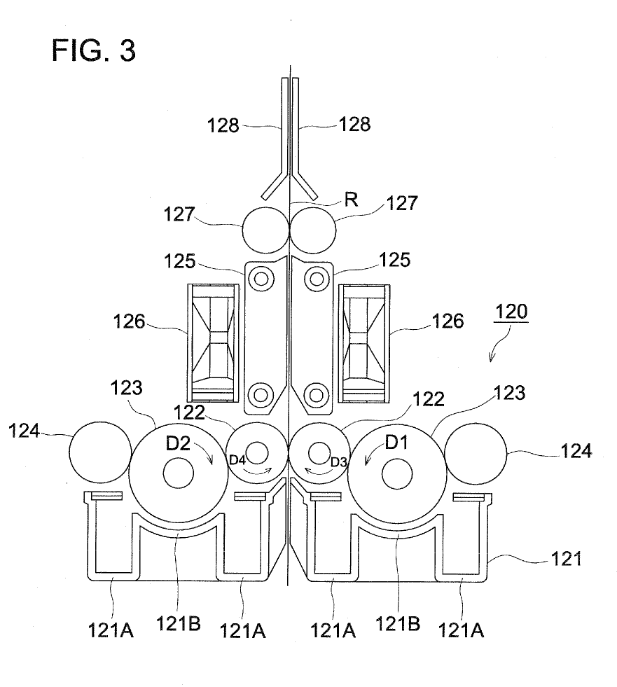

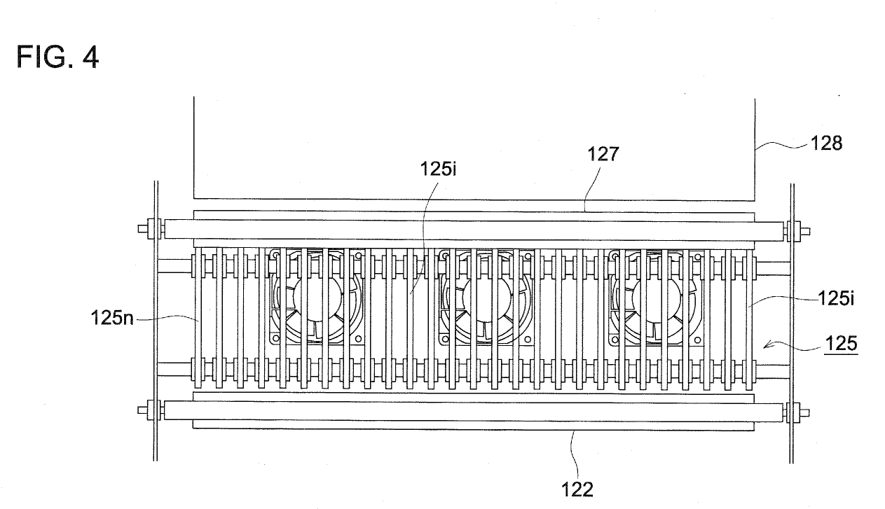

The structures and operations of sheet moisturizing section 120 will be explained as follows, referring to FIGS. 2 to 4. FIG. 2 is a diagram showing the overall structure of a sheet moisturizing device, FIG. 3 is a diagram showing the structure of a sheet moisturizing section, and FIG. 4 is a side view of a guide member.

Vessel 121 that contains water W for moisturizing a sheet forms four rectangular water-tanks 121A each being slightly longer than the maximum width (sheet length in the direction perpendicular to the conveyance direction) of sheet S to be conveyed.

One water-supplying pan 121B is formed between two water-tanks 121A on the right side and one water-supplying pan 121B is formed between two water-tanks 121A on the left side.

Each of the two water-supplying pans 121B has a circular-arc-shaped inner circumferential surface that corresponds to a cylindrical outer circumferential surface of water-supplying roller 123.

Water W is supplied to the water-supplying pan 121B from water-supplying pipe 131, and a water level of water contained in the water-supplying pan 121B is maintained to be constant through overflowing.

A pair of the water-supplying rollers 123 each being arranged through a prescribed distance from an inner circumferential surface of the water-supplying pan 121B are arranged above the water-supplying pan 121B, and a lower portion of the water-supplying rollers 123 is immersed in water that is contained in the water-supplying pan 121B.

Each of the water-supplying rollers 123 is composed of a rubber roller wherein a rubber layer is formed on a metal axial core, and the water-supplying rollers 123 rotate respectively in the directions shown by arrows D1 and D2.

A pair of moisturizing rollers 122 representing moisturizing devices are arranged so that they may come into contact with water-supplying rollers 123, and the paired moisturizing rollers 122 come into contact with each other.

Each of the moisturizing rollers 122 is composed of a rubber roller wherein a rubber layer is formed on a metal axial core, and they rotate respectively in the directions shown by arrows D3 and D4.

Either one of the paired moisturizing rollers 122 is driven to rotate by a driving source (not shown) to rotate as a driving roller, and another moisturizing roller 122 and water-supplying roller 123 are driven by the driving roller to rotate.

The numeral 124 is a regulating member that comes in contact with the water-supplying roller 123.

The regulating member 124 is composed of a metal cylindrical body, and it is driven by the water-supplying roller 123 to rotate.

The numeral 130 represents a water tank, 131 represents a water-supplying pipe, 132 represents a drain pipe and 133 represent a filter.

Water W is supplied from water tank 130 to water-supplying pan 121B of vessel 121 through water-supplying pipe 131 by pump (not shown), and it flows back from vessel 121 to water tank 130 through drain pipe 132.

Foreign substances such as paper dust mixed in water W in the course of moisturizing are filtered by filter 133, and water W circulates between water tank 130 and vessel 121.

How to moisturize sheet S, namely, how to supply water to sheet S is conducted as follows.

Sheet S is carried into sheet moisturizing section 120 by conveyance rollers 105, and is conveyed by moisturizing rollers 122.

Water W is supplied to an outer circumferential surface of each moisturizing roller 122 from vessel 121 through water-supplying roller 123, thus, sheet S is moisturized continuously while it continues to be conveyed.

On an outer circumferential surface of the water-supplying roller 123, there is formed a uniform water film which is further uniformed by regulating member 124.

In the course of moisturizing, foreign substances such as paper dust coming from sheet S adhere to moisturizing rollers 122, and further come to be mixed in water W, and the foreign substances mixed in the water w are filtered by filter 133.

In the upper portion of the paired moisturizing rollers 122 which are at the downstream side in the conveyance direction for sheet S, there are arranged a pair of guide members 125 that guide the sheet S upward vertically, conveyance rollers 127 and a pair of guide members 128.

A pair of fans 126 each sending dry air are arranged behind the guide members 125 to be symmetrical about conveyance path R.

Guide members 125 and 128 will be explained as follows, referring to FIG. 4.

The paired guide members 125 each having the structure which are arranged to be symmetrical from side to side about conveyance path R, as shown in FIG. 3.

Each of the paired guide members 125 has many guide ribs 125i to 125n which are in parallel with the conveyance direction, as shown in FIG. 4. As a form of the rib, it may also be one that is inclined from the conveyance direction, in addition to those which are in parallel to the conveyance direction as illustrated, and it may also be one that is curved to be in a waveform, in addition to those which are linear as illustrated.

Guide member 125 is made of a material that hardly gets dewy, namely, a material of resin such as polyacetal.

Immediately after the moisturizing processing, namely, immediately at the downstream side of moisturizing roller 122, excessive moisture exists on a surface of sheet S in many cases, and a guide member tends to get dewy, and a sheet easily cling to the guide member.

When using a flat-plate-shaped guide member, namely, when using the one whose guide surface is flat-plate-shaped, there is sometimes an occasion where conveyance troubles are caused by clinging.

In the sheet moisturizing section 120, dew condensation wherein waterdrops are formed on a surface of a guide member is easily generated, because humidity tends to be high.

Due to waterdrops resulting from the dew condensation, a sheet clings to a guide member and causes conveyance troubles.

It was possible to prevent clinging of sheet S, by forming guide member 125 representing the first guide member arranged at immediate downstream side of the moisturizing roller 122 with guide ribs 125i to 125n which are made of resin.

With respect to a form of the guide member 125, it is important that sheet S can be guided upward vertically and linearly by the form of the guide member.

Since the guide member 125, representing the first guide member arranged at immediately downstream side of the moisturizing roller 122 so that sheet S passed through the moisturizing roller 122 representing a moisturizing device may be guided first, has guide ribs 125i to 125n, and it guides sheet S in the vertical direction, it is possible to prevent that dew condensation causes sheet S to cling to the guide member 125.

When the direction for guiding sheet S is deflected from the vertical direction, or when conveyance path R formed by the guide member 125 is deflected, refraction caused by skewing of guided sheet S causes sheet S to come in contact with a guide member, to cling to it easily.

With respect to accuracy of the vertical direction representing a guiding direction of guide member 125, if an angle of inclination is small, an inclination from the vertical direction is allowed, but it is preferable that the angle of inclination is 30° or less.

It is further preferable that a length in the conveyance direction for guide member 125 is 100 to 300 mm.

When a length in the conveyance direction for guide member 125 is shorter than 100 mm, conveyance troubles caused by dew condensation tends to be generated at the downstream side of guide member 125. When a length in the conveyance direction for the guide member is longer than 300 mm, a length of the conveyance path is increased to enlarge an apparatus.

Fan 126 is arranged behind the guide member 125.

Since the guide member 125 is in a rib shape without being a plate, air coming from fan 126 passes through the guide member 125 to be blown against sheet S, thus, sheet S is subjected to moisture conditioning.

The sheet S that has passed through guide member 125 is conveyed by a pair of conveyance rollers 127, and is guided upward by guide member 128 representing a second guide member.

Conveyance roller 127 is composed of a roller that has a uniform conveyance surface for a length in the axial direction that is greater than the maximum width of sheet S, and comes in contact evenly the overall surface of sheet S, thus, uneven moisturizing is prevented.

The guide member 128 is of a sheet-metal construction, and it is composed of one sheet or of divided plural sheets both being in the conveyance direction, to guide sheet S upward vertically.

In the same way as in the guide member 125, the guide member 128 also has a guide surface that guides sheet S upward vertically.

In the case of conveyance path R for the moisturized sheet S, it is important that the guide member immediately at the downstream side of the moisturizing roller 122 is rib-shaped without being a flat plate and is made of resin representing a material that hardly gets dewy.

Further, at the position that is away from a moisturizing device and is relatively low in terms of humidity, it is possible to guide the sheet S sufficiently with a guide member that is in a shape of a flat plate.

Incidentally, it is preferable that the conveyance path R formed by the guide member 128 is also vertical.

When a guide surface of the guide member 128 is deviated from the vertical direction, conveyance troubles caused by a sheet inclination tend to happen.

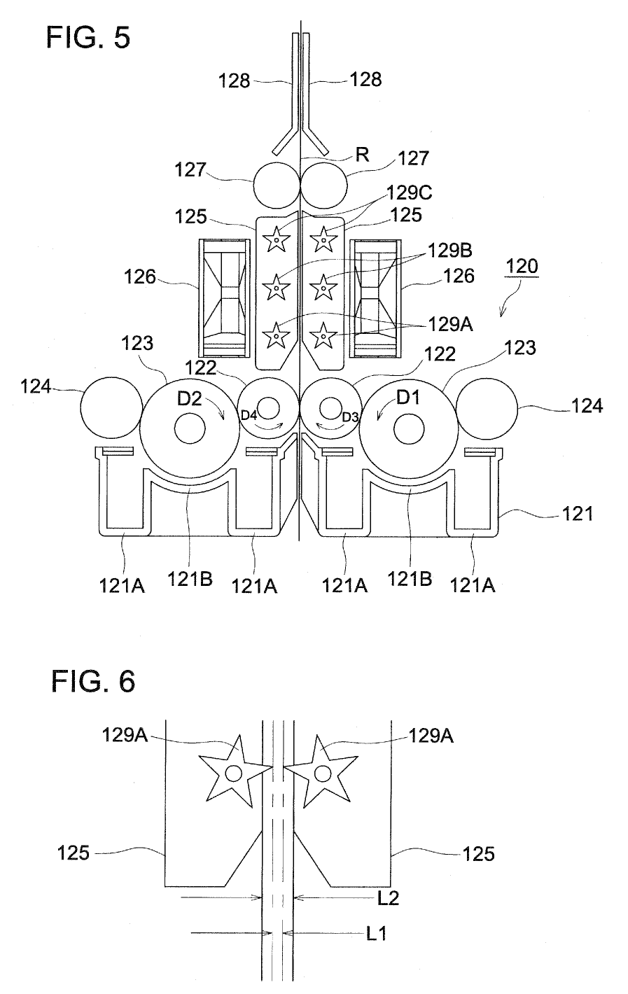

FIG. 5 shows another embodiment of the invention.

In the embodiment shown in FIG. 5, guide members 129A, 129B and 129C each being composed of a toothed wheel are provided in the conveyance path where the guide member 125 having a guide rib is arranged. Each of the guide members 129A, 129B and 129C is a pair of toothed wheels which are arranged to be symmetrical about the conveyance path R as illustrated. Paired guide members 129A are arranged at the upstream side of the guide member 125, paired guide members 129B are arranged at the central portion of the guide member 125 and the paired guide members 129C are arranged at the downstream side of the guide member 125, and each of them is composed of plural toothed wheels arranged in the conveyance direction.

In each of the guide members 129A, 129B and 129C, distance L1 between an edge of a tooth of the toothed wheel and an edge of a tooth of the toothed wheel representing a counterpart is smaller than distance L2 between guide surfaces of the paired guide members 125, whereby, chances for sheet S to touch the guide member 125 are lessened.

It is further possible to provide the toothed wheel at the position of the guide member 128.

In the present embodiment, clinging of sheet S is prevented more efficiently by the guide members 129A, 129B and 129C, resulting in stable conveyance.

### <Decurl Device>

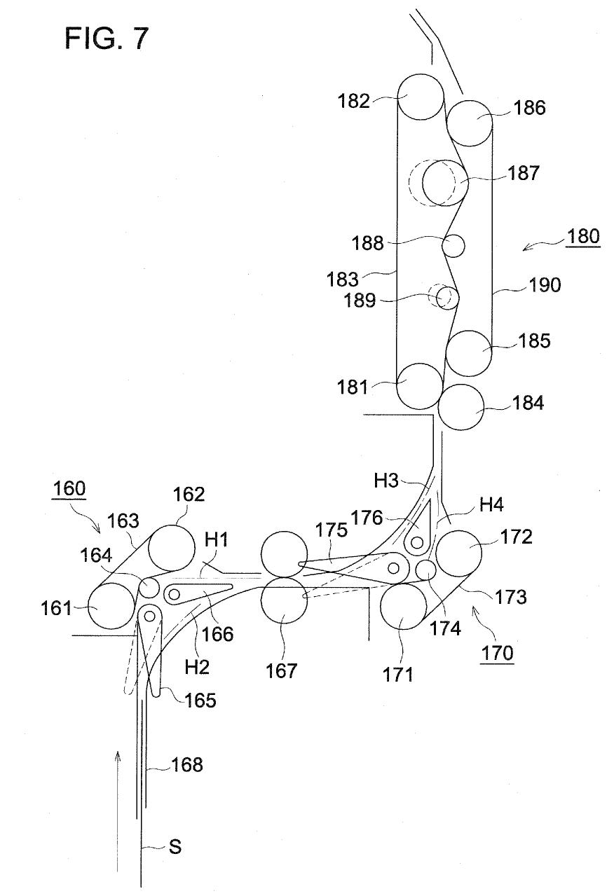

A decurl device will be explained, referring to FIG. 7.

FIG. 7 is an enlarged view of a decurl device which is composed of first decurl section 160, second decurl section 170 and third decurl section 180 in FIG. 2.

In the first decurl section 160, belt 163 is entrained about a pair of rollers 161 and 162, and pressing roller 164 comes in contact with the belt 163.

As illustrated, the pressing roller 164 presses the belt 163 and the intermediate position between roller 161 and roller 162, and bends the belt 163.

As a result, there is formed conveyance path H1 that deviates sheet S to the right direction in the drawing by rollers 161 and 162, belt 163 and pressing roller 164.

The numeral 165 represents a switching gate that guides sheet S to switch to conveyance path H1 or to conveyance path H2, and sheet S is guided to conveyance path H1 when the switching gate is in a position shown with solid lines, while, the sheet S is guided to conveyance path H2 when the switching gate is in a position shown with dotted lines.

Sheet S guided to conveyance path H1 is bent by rollers 161 and 162, belt 163 and by pressing roller 164, so that a curl is corrected.

Sheet S guided to conveyance path H2 is not corrected in terms of curling, because it is conveyed through conveyance path H2 whose radius of curvature is large.

Sheet S is conveyed by conveyance roller 167 from first decurl section 160 to second decurl section 170.

In the second decurl section 170, belt 173 is entrained about a pair of rollers 171 and 172, and pressing roller 174 comes in contact with belt 173.

The pressing roller 174 presses the belt 173 at the intermediate position between roller 171 and roller 172, to bend the belt 173.

As a result, there is formed conveyance path H4 that deviates sheet S to the left direction in the drawing by rollers 171 and 172, belt 173 and by pressing roller 174.

The numeral 175 represents a switching gate that guides sheet S to switch to conveyance path H3 or to conveyance path H4, and sheet S is guided to conveyance path H4 when the switching gate is in a position shown with solid lines, while, the sheet S is guided to conveyance path H3 when the switching gate is in a position shown with dotted lines.

Sheet S guided to conveyance path H4 is bent by rollers 171 and 172, belt 173 and by pressing roller 174, so that a curl is corrected.

Sheet S guided to conveyance path H3 is not corrected in terms of curling, because it is conveyed through conveyance path whose radius of curvature is large.

In the third decurl section 180, belt 183 is entrained about rollers 181, 182, 187 and 189, while, belt 190 is entrained about rollers 185, 186 and 188.

As illustrated, rollers 181, 182, 185 to 189 are arranged so that belts 183 and 190 may meander.

As illustrated, belt 183 is in contact with belt 190, and the contact section interposes sheet S to convey it. The numeral 184 represents a conveyance roller that introduces sheets S to decurl section 180.

Belt 183 is entrained about rollers 187 and 189, namely, the rollers 187 and 189 are in contact with an inner circumferential surface of belt 183, and they press belt 183 from its outer circumferential surface side.

Belt 190 is entrained about roller 188, namely, roller 188 is in contact with an inner circumferential surface of belt 190 and presses belt 183 from its outer circumferential surface side.

Each of rollers 187 and 189 can be displaced between a solid line position and a dotted line position.

When rollers 187 and 189 are in the solid line positions, sheet S is bent toward the left direction and a curl is corrected, while, when they are in the dotted line positions, a curl is not corrected.

Further, when rollers 189 are in the solid line positions, sheet S is bent toward the right direction to correct a curl, while, when they are in the dotted line positions, a curl is not corrected.

When rollers 189 are in the solid line positions, rollers 188 causes sheet S to be bent toward the right direction to correct a curl.

Third decurl section 180 corrects microscopic curls.

Namely, large curls are corrected in the first decurl section 160 and the second decurl section 170, while, residual microscopic curls are corrected in the third decurl section 180.

What is claimed is:

1. A sheet moisturizing device having a moisturizing section that moisturizes a sheet and a guide that guides the sheet which has been moisturized by the moisturizing section, the guide comprising:
a first guide member made of resin having a plurality of ribs, arranged immediately downstream of the moisturizing section in a sheet conveyance direction, which guides the sheet in a vertical direction.

2. The sheet moisturizing device of claim 1, further comprising a fan provided behind the first guide member when viewed from a conveyance path of the sheet, which blows against the sheet.

3. The sheet moisturizing device of claim 1, wherein the guide further comprises a second guide member having a flat shaped plate, provided downstream of the first guide member in the sheet conveyance direction, which guides the sheet.

4. The sheet moisturizing device of claim 3, wherein the guide further comprises a conveyance roller provided between the first guide member and the second guide member, which guides and conveys the sheet.

5. The sheet moisturizing device of claim 1, wherein the conveyance path formed by the first guide member is linear, a length of the conveyance path in the sheet conveyance direction is 100 mm to 300 mm.

6. The sheet moisturizing device of claim 1, wherein the guide further comprises a toothed wheel which guides the sheet.

7. An image forming apparatus provided with an image forming section that forms an image on a sheet and with the sheet moisturizing device described in claim 1 that moisturizes the sheet on which the image has been formed in the image forming section.
